(19) United States
(12) Patent Application Publication
(10) Pub. No.: US 2024/0013289 A1
(43) Pub. Date: Jan. 11, 2024

(54) Rental Property Management System

(71) Applicants: Luca Zambello, Los Angeles, CA (US); David Phillips, Los Angeles, CA (US); LLuis Miquel Gonzalez Sola, Los Angeles, CA (US); Giovanni Moretto, Paese(TV) (IT)

(72) Inventors: Luca Zambello, Los Angeles, CA (US); David Phillips, Los Angeles, CA (US); LLuis Miquel Gonzalez Sola, Los Angeles, CA (US); Giovanni Moretto, Paese(TV) (IT)

(73) Assignee: Jurny, Inc., Los Angeles, CA (US)

(21) Appl. No.: 18/371,447

(22) Filed: Sep. 22, 2023

Related U.S. Application Data
(63) Continuation of application No. 16/885,258, filed on May 27, 2020, now abandoned.
(60) Provisional application No. 63/023,242, filed on May 11, 2020.

(51) Int. Cl. G06Q 30/0645; G06Q 50/16

(52) U.S. Cl. CPC G06Q 30/0645; G06Q 50/163

(57) ABSTRACT

A system and method is provided for using an application operating on a smartphone and a network-connected host to book a reservation for a rental unit having a plurality of smart locking devices and to control the devices during said user's stay, where different devices are associated with different network-connected services. In one embodiment, the host is configured to identify the devices, identify corresponding services, acquire access code requirements for the same, generate a compliant access code, and provide the access code to the user and the smart service/device, along with reservation information. Not only will this allow the smart service and/or device to prepare for the user's visit (programming the smart device so that the access code works during the user's stay), but it will provide the user with a single access code that works on all smart locking devices during the user's stay.

### BACKGROUND OF THE INVENTION

### 1. Field of the Invention

The present invention relates to controlling access to rental units, or more particularly, to a system and method for using at least a smart locking device, a smart service, a network-connected host, and an application (e.g., operating on a smartphone) to at least control access to a unit during a particular time period (e.g., starting on a check-in date and ending on a check-out date), wherein said network-connected host is configured to generate a code that can be used to at least unlock said smart locking device, transmit said code to said application, and transmit said code, along with said check-in date and said check-out date, to said smart service, said network-connected host being used to control access to said unit during said particular time period via said smart locking device.

### 2. Description of Related Art

Smart home systems are becoming more and more commonplace, allowing a user to control features (e.g., lighting, security, entertainment, etc.) within their home from a remote location (e.g., from another room, city, state, etc.).

A smart home system generally included three components: (1) at least one smart device; (2) a smart service; and (3) a user-interface. A smart device is an electronic device (e.g., light fixture, thermostat, etc.) that can be controlled remotely; generally responsive to commands (e.g., on, off, etc.). The smart service, which may be located locally (e.g., within the house) and/or remotely (e.g., over the Internet), and may communicate with the smart device via a wired and/or wireless connection (e.g., Bluetooth, Zigbee, NFC, Wi-Fi, LiFi, 3G, etc.), is responsible for receiving commands from a user (i.e., via the user-interface) and controlling the smart device accordingly. The user-interface may also be located locally (e.g., a panel within the house) and/or remotely (e.g., as an application operating in the user's smartphone) and is responsible for sending commands to the smart service, generally at the user's request.

For example, when a user is driving home from work, the user may open an application on their smartphone and request that certain lights be turned on, so that the house is illuminated upon their arrival. By way of other examples, the user could use the same application to control the temperature of the house, the entertainment system (e.g., be greeted by music), open the garage door, etc. All of this can generally be accomplished from a single application that is provided by, and configured to operate with, a particular smart home system (e.g., Amazon's Smart Home System™). If more than one smart home system is being used (e.g., one to control appliances, one to control access to the house, etc.), then more than one application is generally required. For example, one may use a Nest™ system to control temperature and a Philips' Hue™ system to control lighting; the prior being controlled via a first (Nest) application, and the latter being controlled via a second (Philips) application.

Obviously, this gets even more complicated if more smart devices are being used. For example, different applications may be required to control temperature (furnace, A/C), lighting (on, off, color, brightness), appliances (e.g., refrigerator, washer, dryer, coffee maker), security (alarm, cameras, sensors), entertainment (audio, video), and/or locks (doors, gates, garage). And this gets even more complicated if there are common smart devices (e.g., a door, pool, lighting, etc. used by more than one individual and/or family) or the individual and/or family owns more than one home (e.g., a primary residence and a summer home). And it gets even more complicated if the house (or unit) in question is being used by different individuals (or families) during different time periods (e.g., airbnb™, hotels, time shares, etc.).

Thus, a need exists for a system and method that provides easy access and control over a plurality of smart devices, including smart locking devices, controlled by different systems (or services), in a plurality of unit, during different time periods. Such a system and method would allow a user (e.g., a renter) to control different smart devices, including smart locking devices, within a unit from a check-in date until a check-out date. The system and method would also prevent said user from controlling said smart devices, and gaining access to said unit, during other periods of time.

### SUMMARY OF THE INVENTION

The present invention provides a system and method for using an application operating on a smartphone and a network-connected host to at least receive information on a rental unit during a time period (e.g., from a check-in date until a check-out date) and to control a plurality of smart devices, including at least a smart locking device, during said time period, where different smart devices are controlled by (or part of) different services (or systems) that operate independently from one another, thereby providing a user with easy access to and control over said information and said devices, respectively.

Preferred embodiments of the present invention include a user device (e.g., a smartphone), a host device, at least one smart home (e.g., including at least one smart device), and at least one smart service in communication with one another via a wide area network (WAN), such as the Internet. In alternate embodiments, the system may further include at least one reservation system (e.g., hotels.com™, etc.).

A primary objective of the present invention is to allow an individual to easily access and control a smart home (or smart device therein) during a pre-determined period of time. Thus, a user device may be used to reserve the smart home (rental) from a check-in date through a check-out date. This may be accomplished by interacting with the host device or one of a plurality of known reservation systems (e.g., airbnb™, etc.). If a reservation is made through a reservation system, the reservation (e.g., user information, check-in date, check-out date, rental unit, etc.) may be provided to the host device, where the reservation is be stored.

Once a reservation has been made, an application operating on the user device can be used to acquire information on the smart home and to access and/or control the same. As discussed above, the smart home should have at least one smart device (e.g., a smart locking device, light fixture, thermostat, etc.). In certain embodiments, the smart device may be intelligent enough to operate on its own (e.g., to communicate directly with the user device). In other embodiments, control requires communication (at least in part) with a smart service.

As discussed above, different smart devices may require different smart services. For example, a first smart service may be used to control at least a first feature (e.g., common locks, including access to the building, pool, parking structure, etc.), a second smart service may be used to control at least a second feature (e.g., access to the rental unit, etc.), and a third smart service may be used to control at least a third feature (e.g., accessories, such as temperature, lighting, etc.).

It should be appreciated that the present invention is not limited to any particular type of smart device or service associated therewith. For example, the smart device may control temperature (furnace, A/C), lighting (on, off, color, brightness), appliances (e.g., refrigerator, washer, dryer, coffee maker), security (alarm, cameras, sensors), entertainment (audio, video, Wi-Fi), locks (doors, gates, garage), and other features generally known to those skilled in the art. The smart device may also be communicated with directly, either locally (e.g., via Bluetooth, NFC, an associated keypad, etc.) or remotely (e.g., via Wi-Fi, 3G, the Internet, etc.), or via a corresponding service. In other words, commands may be sent to the device's service (e.g., via the Internet), which in turn controls the device accordingly (e.g., by transmitting a corresponding command from the service to the device).

The service may also (or alternatively) be used to program the device. For example, if the smart device is a lock (i.e., smart locking device), the device's service may be used to program the lock with at least one corresponding code and, in certain embodiments, an activation date/time (e.g., check-in date) and deactivation date/time (e.g., check-out date). This would allow the user to gain access to the unit (or the like) during a particular time period and prevent the user from gaining access to the unit during alternate time periods (e.g., before check in, after check out, etc.). In other embodiments (e.g., if the device is not programmable), the service may be programable (e.g., with a particular code, a check-in date, a check-out date, etc.). In this embodiment, the code would be provided to the service and the service would determine whether the device (e.g., lock) should be controlled (e.g., unlocked).

As discussed above, a smart home may have smart devices that are common (common to more than one unit) and smart devices that are unique (unique to a particular unit). For example, an apartment building may have a common front door, pool door, and garage door, and unique unit doors (doors to each apartment). It is not unusual for the common doors (or associated smart locking devices) to utilize a first smart service and unit doors (or associated smart locking devices) to utilize a second smart service. Hence, the need for a system and method that simplifies control of different smart devices and/or services.

In one embodiment of the present invention, the user device (or application operating thereon) may communicate with and/or control a smart device remotely (e.g., via the Internet, etc.). In this embodiment, a communication (e.g. command, etc.) will most likely be initiated by the user (e.g., via the user device, or the application operating thereon), communicated over the Internet, and provided (either directly or indirectly) to the smart device.

Alternatively, or in addition, the smart device may be communicated with and/or be controlled locally (e.g., via Bluetooth, NFC, a keypad, etc.). For example, a door may be unlocked by entering a unique code on the user device (or the application operating thereon). The code would then be sent to the smart locking device via a wireless signal, such as Bluetooth, NFC, etc. Alternatively, the user device may provide the user with (e.g., display) the unique code, thereby allowing the user to enter it via a keypad located adjacent (or near) the door.

With respect to the access code, the code for each smart device is typically selected by the smart service. Thus, a service for a first common door (e.g., parking structure) may select and provide a first code (e.g., 1234), a service for a second common door (e.g., pool) may select and provide a second code (e.g., 987654), and a service for a unit door (e.g., front door) may select and provide a third code (e.g., Name123). This can be quite confusing for the user, especially when the codes are only going to be used for a limited amount of time (e.g., from the check-in date until the check-out date). And because these codes can be changed at will (e.g., if the service detects a security issue), a smart locking device may require more than one code during the user's stay.

The present invention solves this problem by (i) identifying the smart devices that are within (or associated with) the unit, (ii) identifying the corresponding smart services, (iii) acquiring information on each smart service and/or device (e.g., access code requirements, etc.), (iv) generating at least one access code that complies with each code requirement for each smart service and/or device, and (v) providing the access code to the user (e.g., via the application) and the access code and reservation information (e.g., unit, check-in date, check out date, etc.) to the smart service and/or device. Not only will this allow the smart service and/or device to prepare for the user's visit (e.g., programming the smart device so that the code only works during the user's stay), but it will provide the user with (preferably) a single code that works on all smart devices (e.g., all smart locking devices) during the user's stay.

Generating a single unique code that will work on all smart locking devices will generally require an understanding of requirements for each smart locking device. For example, if a first service for controlling access to the building requires at least a four digit code, a second service for controlling access to the pool requires a six digit code, and a third service for controlling access to the unit requires at least a three digit code, then a six digit code would meet the requirements for each and every service. However, the exact code may require further consideration to ensure that it is indeed unique. By way of example, the code “123456” may meet the requirements for each service but may already be used by at least one service and linked to a different activation and/or deactivation date/time. Thus, in one embodiment of the present invention, a code should be generated that not only meets the requirements but is unique from other codes that are already in use. A code should be considered unique (and therefore acceptable) if it is not already in use for dates that overlap the rental period for the user.

As discussed above, an application may be downloaded to and operated on a user device, such as a smartphone, and can be used (in certain embodiments) to make a reservation and (in other embodiments) to present rental (including smart device) information to the user and allow a user to control certain features (e.g., turn on lights, adjust temperature, open doors, gates, structures, etc.). For example, a user may be presented with information concerning parking, Wi-Fi, amenities (e.g., pool, gym, etc.), and access code, and may be allowed to control features, such as temperature, unlocking doors, locking doors, etc.

A more complete understanding of a system and method for using an application operating on a smartphone and a network-connected host to at least receive information on a rental unit during a time period and to control a plurality of smart devices, including at least a smart locking device, during said time period, will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIGS. 1, 5, 6 and 7 illustrate ways in which the present invention may operate, wherein a smartphone phone, a host device, a smart service, a reservation system, and at least one smart home device are in communication with one another (or certain ones) over a wide area network, such as the Internet;

FIG. 2 illustrates components that may exist within the smartphone illustrated in FIG. 1 in accordance with one embodiment of the present invention;

FIG. 3 illustrates components that may exist within the host device illustrated in FIG. 1 in accordance with one embodiment of the present invention;

FIG. 4 illustrates components that may exist within the smart home device illustrated in FIG. 1 in accordance with one embodiment of the present invention;

FIGS. 8A, 8B, 9A, 9B, 10A, 10B and 10C illustrate ways in which an application operating on a smartphone can be used to control at least one smart home device in accordance with certain embodiments of the present invention;

FIG. 11 provides a method for generating and disseminating at least one access code for controlling at least one smart locking device in accordance with one embodiment of the present invention;

FIG. 12 provides a method for using the access code generated in FIG. 11 to provide and limit access to a unit for a period of time (from a check-in date until a check-out date) in accordance with one embodiment of the present invention;

FIGS. 13 and 14 depict information that may be stored and used to generate and control certain smart devices within (or associated with) a particular unit in accordance with one embodiment of the present invention;

FIGS. 15A-D provide exemplary screen shots of an application operating on a smartphone, said application being used to reserve a particular unit for a particular period of time (e.g., from a check-in date until a check-out date);

FIG. 16A-E provides exemplary screen shots of an application operating on a smartphone, said application being used to control smart devices within said particular unit and receive information on said unit during said particular period of time (e.g., from a check-in date until a check-out date).

### DETAILED DESCRIPTION OF THE PREFERRED EMBODIMENT

The present invention provides a system and method for using an application operating on a smartphone and a network-connected host to at least receive information on a rental unit during a time period (e.g., from a check-in date until a check-out date) and to control a plurality of smart devices, including at least a smart locking device, during said time period, where different smart devices are controlled by (or part of) different services (or systems) that operate independently from one another, thereby providing a user with easy access to and control over said information and said devices, respectively.

It should be appreciated that while the present invention is described in terms of an application operating on a smartphone that is in communication with a network-connected host via a wide area network (WAN), such as the Internet, and is used to reserve a rental unit for a time period and to receive information on and control smart devices within (or associated with) said rental unit during said time period, the present invention is not so limited. For example, a different user-interface (e.g., software operating on a tablet, laptop, PC, etc.) that has limited capabilities (e.g., is used to control certain smart devices, but not make reservations) and is configured to communicating directly with the smart device (e.g., via Bluetooth or NFC), is within the spirit and scope of the present invention. Similarly, an application for home owners (not rentals) that is configured to communicate with a plurality of smart devices (either directly or via a network-connected host), where different smart devices are controlled by (or part of) different services (or systems), to simplify user control, is also within the spirit and scope of the present invention. In other words, those skilled in the art will appreciated that the present invention can be configured differently, depending on system and/or user requirements.

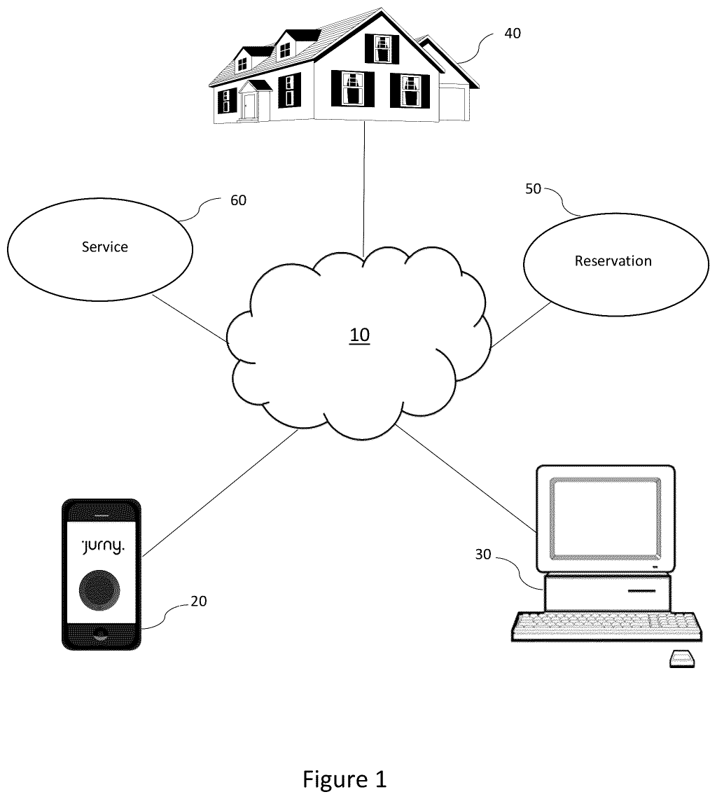

In preferred embodiments of the present invention, as shown in FIG. 1, a user device 20 (e.g., a smartphone), a host device 30, a smart home 40, a reservation system 50, and a smart service 60 are in communication with one another via a WAN such as the Internet. It should be appreciated that the present invention is not limited to system shown in FIG. 1. For example, the system may include different devices, additional devices (e.g., more than one smart home, etc.), or fewer devices. By way of example, the system may further include at least one payment (or banking) device (e.g., Venmo™, Visa™, Chase™, etc.) in communication with the host device 30. This would allow the user via the user device 20 (or a related application operating thereon) to communicate with the host device 30 to search for available rentals, make a reservation, pay for the reservation, check in, and check out, without ever having to communicate (or interact) with another human being. Not only does this provide a one-stop-shopping experience, but it also provide a no-contact-shopping experience, which is extremely helpful in light of the current COVID-19 pandemic; particularly for those individuals that are at-risk (e.g., over the age of 65, have underlying health issues, etc.).

In other embodiments, individual devices may only be configured to communicate with certain other devices. For example, the user device 20 may be configured to communicate with the reservation system 50 (e.g., to make a reservation) and the host device 30, but not the smart home 40 or smart service 60 (at least not directly). The user device 20 may only do so via the host device 30 (indirectly). Obviously, other embodiments (e.g., where the user device 20 can communicated directly with the smart home 40 and/or smart service 60) are also within the spirit and scope of the present invention, depending on system and/or user requirements.

Is should also be appreciated that, while the user device 20 is shown as a smartphone, other user devices are within the spirit and scope of the present invention (e.g., tablets, laptops, PCs, cellular telephones, etc.). And while the host device 30 is shown as a PC, other host devices (or portions thereof, such as servers, applications, memory devices, etc.) are also within the spirit and scope of the present invention. Those skilled in the art will understand that similar devices, or portions thereof (e.g., processors, servers, applications, memory devices, etc.), may also be included in (or part of) each smart service 60 (e.g., Amazon Smart Home System™, August Smart Lock System™) and/or reservation system 50 (airbnb™, Travelocity™, etc.).

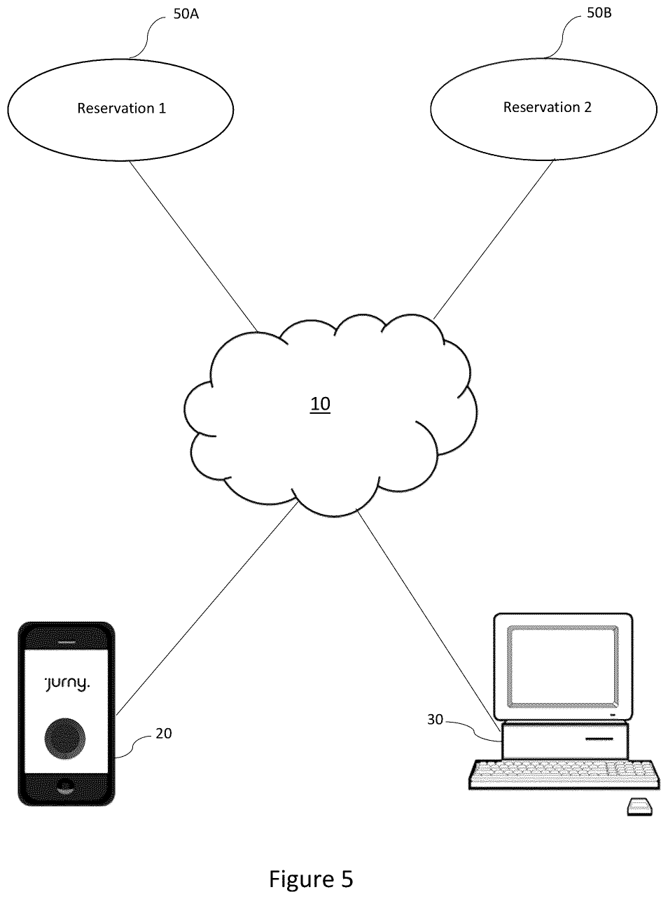

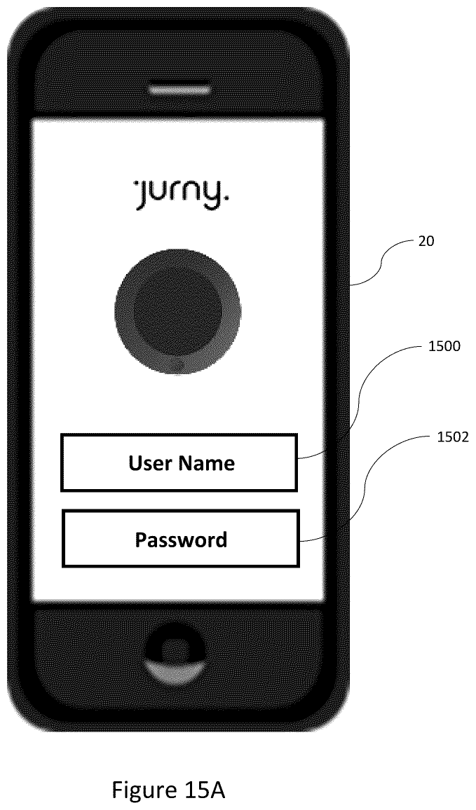

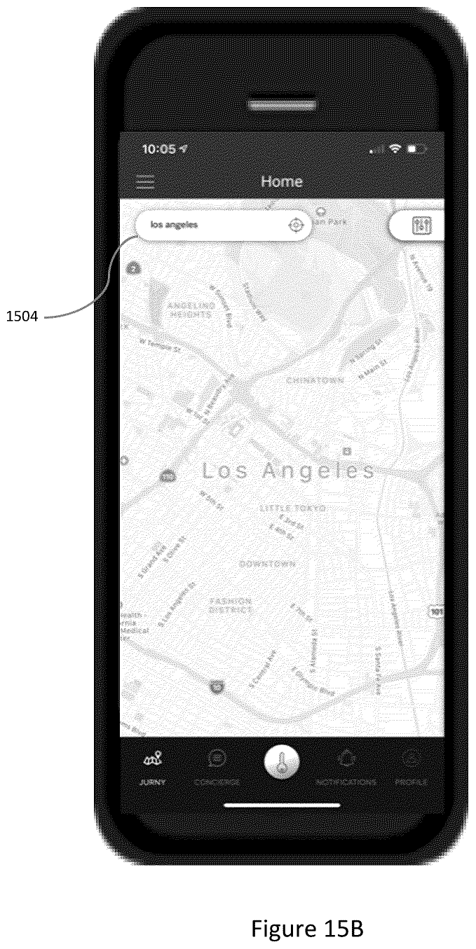

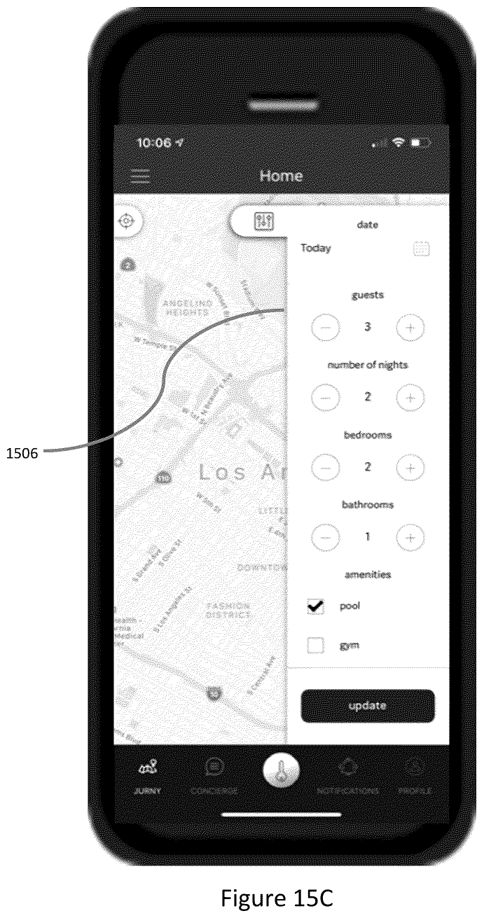

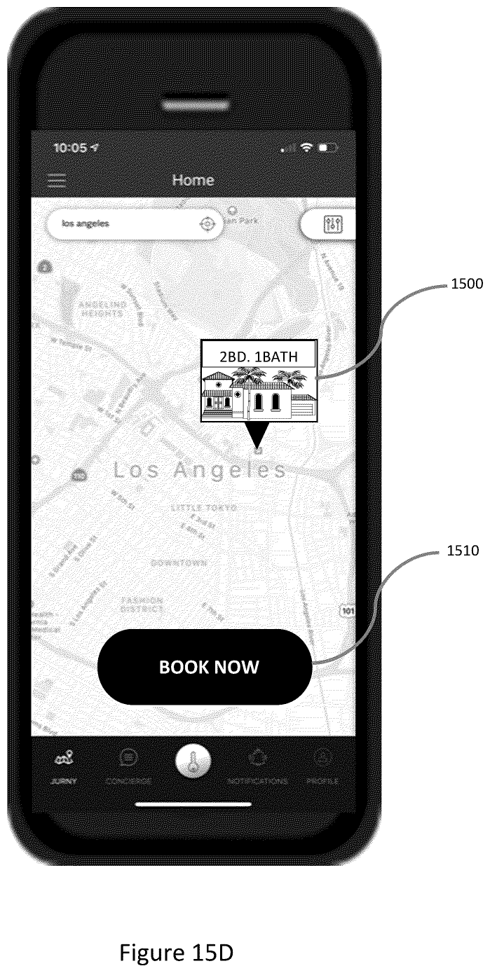

A primary objective of the present invention is to allow an individual to easily access and control a smart home 40 during a pre-determined period of time. Thus, the user may use the user device 20 to reserve the smart home 40 from a check-in date through a check-out date (i.e., make a reservation). This may be accomplished by interacting with the host device 40 (see, e.g., FIG. 15B-D) or one of a plurality of known reservation systems (see, e.g., FIG. 5 at 50A and 50B) (e.g., airbnb™, Travelocity™, hotels.com™, etc.). If a reservation is made through a reservation system, the reservation (e.g., user information, check-in date, check-out date, rental unit ID, etc.), once completed, may be provided to the host device 40, where the reservation can be stored.

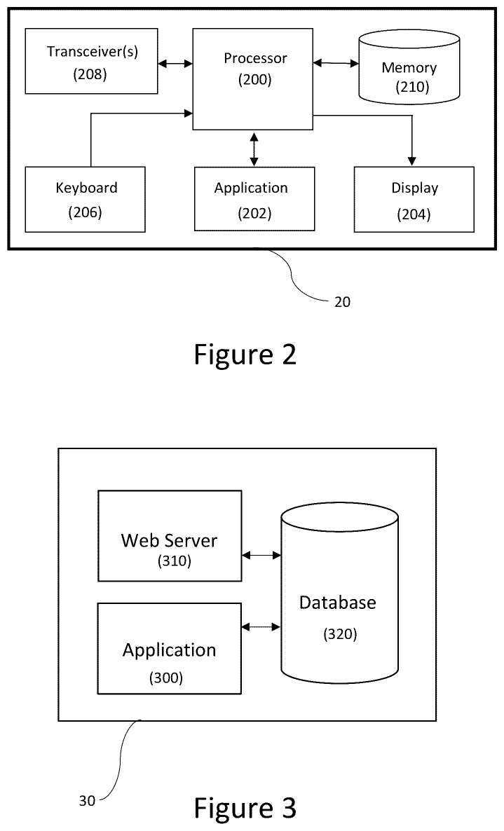

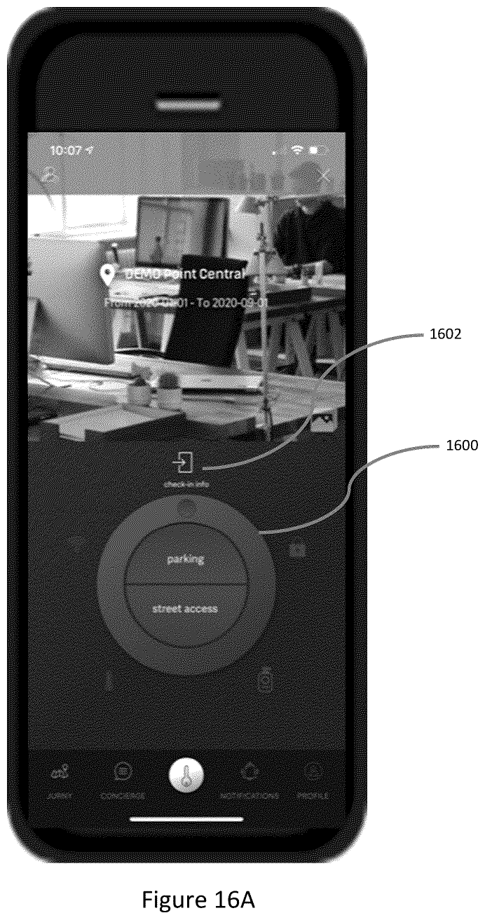

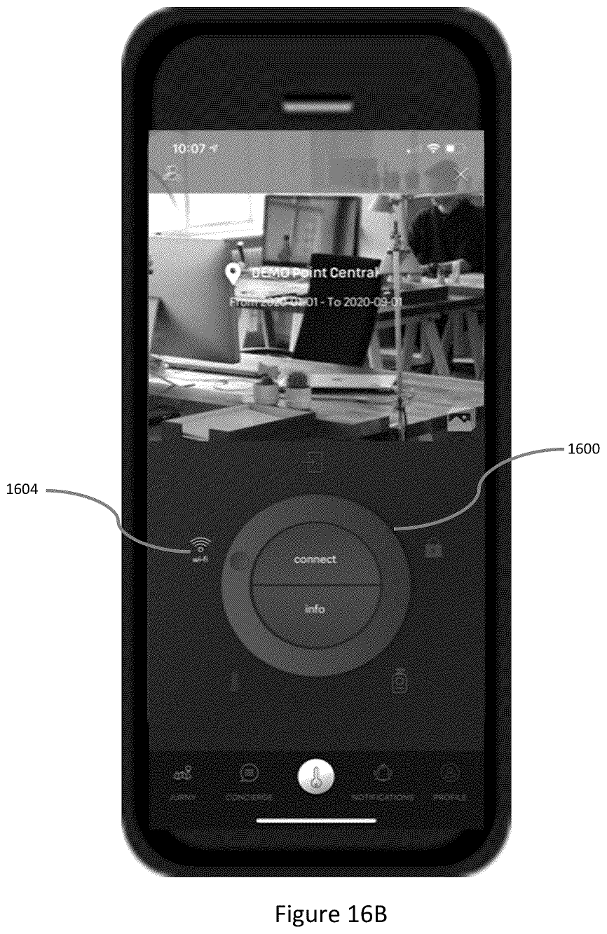

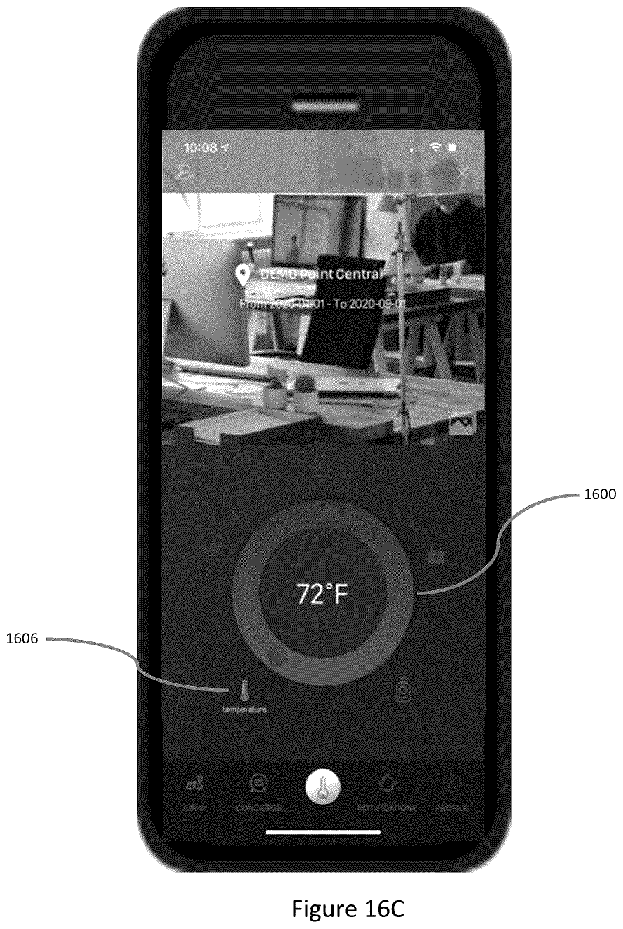

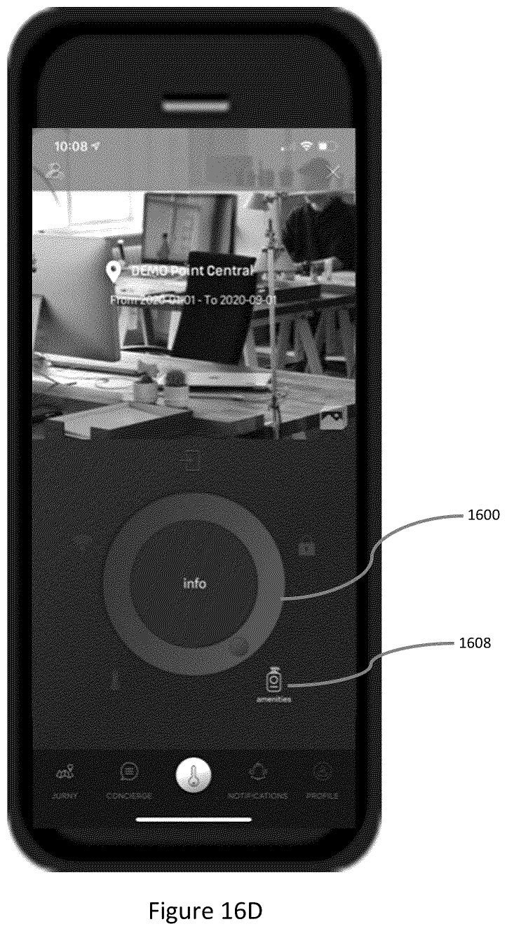

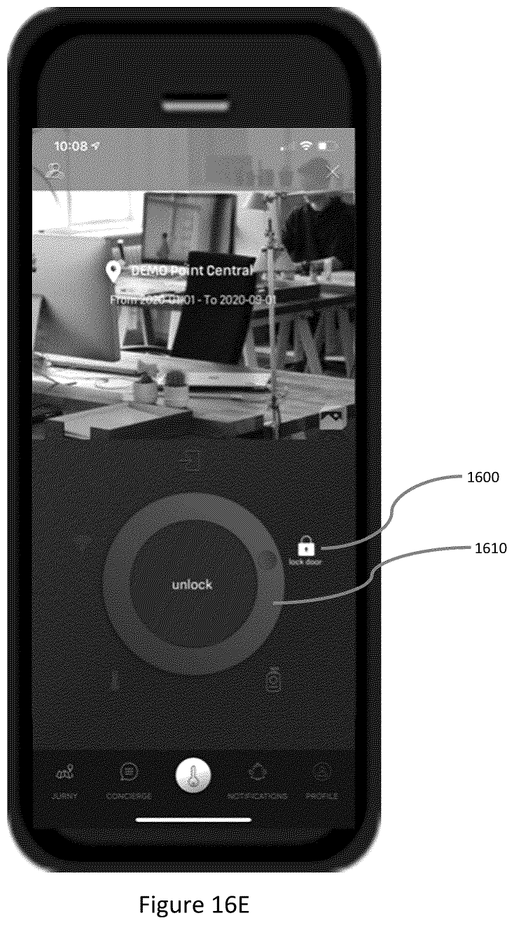

As shown in FIG. 2, the user device 20 may include a processor 200, a transceiver 208 (e.g., for communicating with the reservation system, the host device, and/or the smart home) (e.g., Bluetooth, NFC, Wi-Fi, 3G, etc.), a memory 210 (e.g., for storing user name, password, payment information, application code and/or data, etc.), a keyboard 206, or the like (e.g., touchscreen, microphone for voice commands, etc.), and a display (e.g., LCD, etc.). As shown in FIG. 3, the host device 30 may include at least one web server 310 (e.g., for communicating with the reservation systems, the smart services, the smart homes, and the user devices), at least one application 300 (e.g., allowing a user to make a reservation, acquire information on the smart home, access and/or control the smart home, etc.) (see, e.g., FIGS. 16A-E) and at least one database 320, or the like (e.g., memory device) (e.g., for storing reservations, information on the user (e.g., user name, password, payment information, contact information, etc.), information on the smart home (e.g., Wi-Fi information, parking information, amenities, access code(s), etc.), etc.).

It should be appreciated that the present invention is not limited to the components shown in FIGS. 2 and 3, and a user and/or host device may include different, additional, or fewer components. For example, a user device that includes additional transceivers (e.g., one to communicate remotely (e.g., 3G, 4G, Wi-Fi, etc.) and one to communicate locally (e.g., Bluetooth, NFC, etc.) is within the spirit and scope of the present invention. Similarly, a user device that includes additional components (e.g., GPS for determining location and/or proximity to the smart home) is also within the spirit and scope of the present invention.

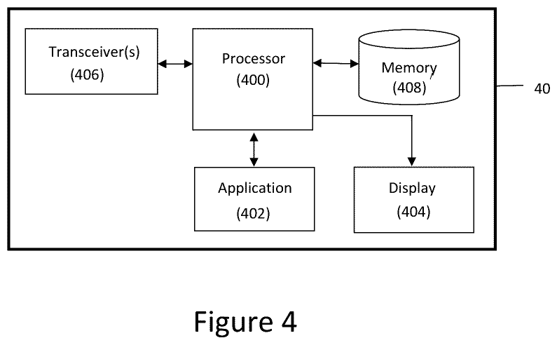

With reference back to FIG. 1, once a reservation has been made, an application operating on the user device 20 (see FIG. 2 at 202) can be used to acquire information on the smart home (rental unit) and to access and/or control the smart home. As discussed above, a smart home 40 will have at least one smart device located within (e.g., a smart locking device, a smart light fixture, a smart thermostat, etc.). This can be seen in FIG. 4, where each smart device may include a processor 400, a transceiver (e.g., Bluetooth, NFC, Wi-Fi, etc.) (e.g., for communicating with the smart service, the user device, etc.), a memory (e.g., for storing data related to the device, such as an access code, temperature, activation date, deactivation date, etc.), an application 402, or the like (e.g., software), and mechanics 404 (e.g., locking mechanism, light fixture, thermostat, etc.). It should be appreciated that the present invention is not limited to the components shown in FIG. 4, and a smart device that includes different, additional, or fewer components is within the spirit and scope of the present invention. For example, if the smart device is a smart locking mechanism it may further include a keypad for entering an access code.

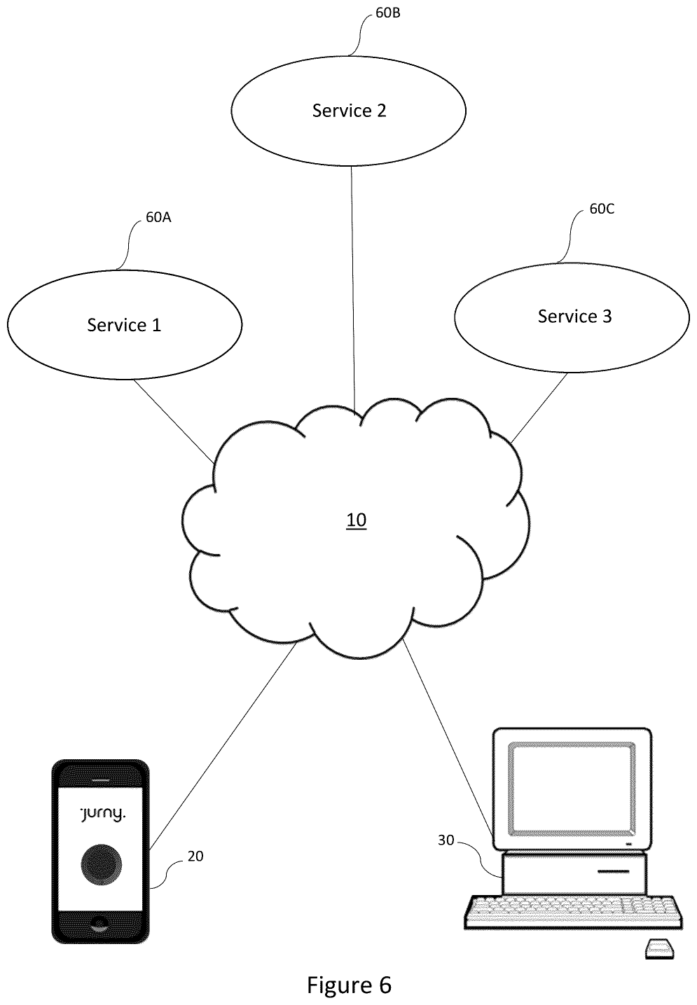

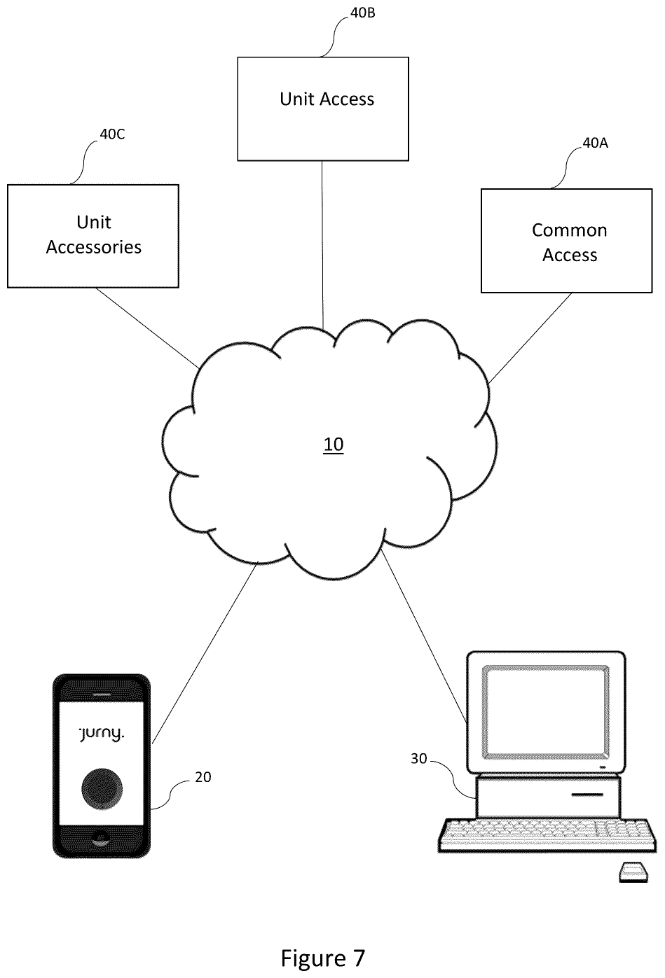

In certain embodiments, the smart device may be intelligent enough to operate on its own (e.g., to communicate directly with the user device). However, in other embodiments, control requires communication (at least in part) with a smart service. As discussed above, different smart devices may require different smart services. This can be seen in FIGS. 6 and 7, where a first smart service 60A is used to control at least a first feature (e.g., common locks 40A, including access to the building, pool, parking structure, etc.), a second smart service 60B is used to control at least a second feature (e.g., access to the rental unit 40B, etc.), and a third smart service 60C is used to control at least a third feature (e.g., accessories 40C, such as temperature, lighting, etc.).

It should be appreciated that the present invention is not limited to any particular type of smart device or service associated therewith. Some smart devices can be communicated with directly, either locally (e.g., via Bluetooth, NFC, an associated keypad, etc.) or remotely (e.g., via Wi-Fi, 3G, the Internet, etc.). Others are communicated with via their corresponding service. In other words, commands may be sent to the device's service (e.g., via the Internet), which in turn controls the device accordingly (e.g., by transmitting a corresponding command from the service to the device).

The service may also (or alternatively) be used to program the device. For example, if the smart device is a lock (i.e., smart locking device), the device's service may be used to program the lock with at least one corresponding code (access code) and, in certain embodiments, an activation date/time (e.g., check-in date) and deactivation date/time (e.g., check-out date). This would allow the user to gain access to the unit (or the like) during a particular time period and prevent the user from gaining access to the unit during alternate time periods (e.g., before check in, after check out, etc.). In other embodiments (e.g., if the device is not programmable), the service may be programable (e.g., with an access code, a check-in date, a check-out date, etc.). In this embodiment, the code would be provided to the service and the service would determine whether the device (e.g., lock) should be controlled (e.g., unlocked). Those skilled in the art will understand that all of the foregoing embodiments (including combinations there) are within the spirit and scope of the present invention. By way of example only, a building lock may be programmable (e.g., via a corresponding service), whereas a unit lock may not be programmable (e.g., access is granted via a corresponding service, which is programmable).

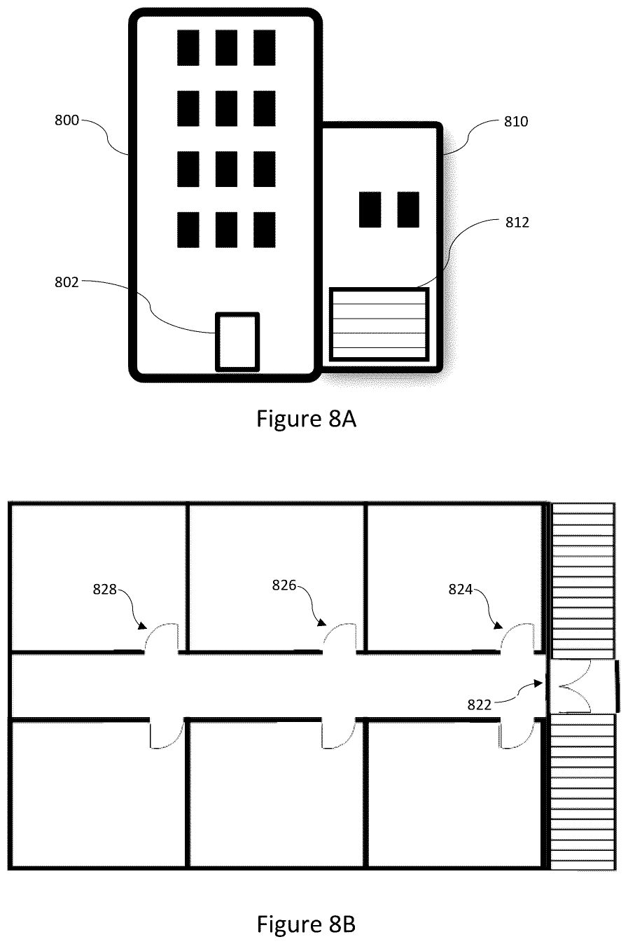

As discussed above, a smart home may have smart devices that are common (used by more than one individual and/or family) and smart devices that are unique to a unit (e.g., used by one individual and/or family at a time). For example, as shown in FIGS. 8A-B, an apartment building 800 may have a common front door 802 and floor door 822 and a parking structure 810 may have a common garage door 812. The apartment building 800 may further have unique (or individual) unit doors (i.e., doors to each apartment) (824, 826, 828). It is not unusual for the common doors (or corresponding smart locking devices) to utilize a first smart service and unit doors (or corresponding smart locking devices) to utilize a second smart service. It is also not unusual for a smart locking device to use a first smart service and other smart devices (e.g., lighting, temperature, etc.) to use a second smart service. Hence the need for a system and method for simplifying communicate with and/or control of different smart devices and/or services.

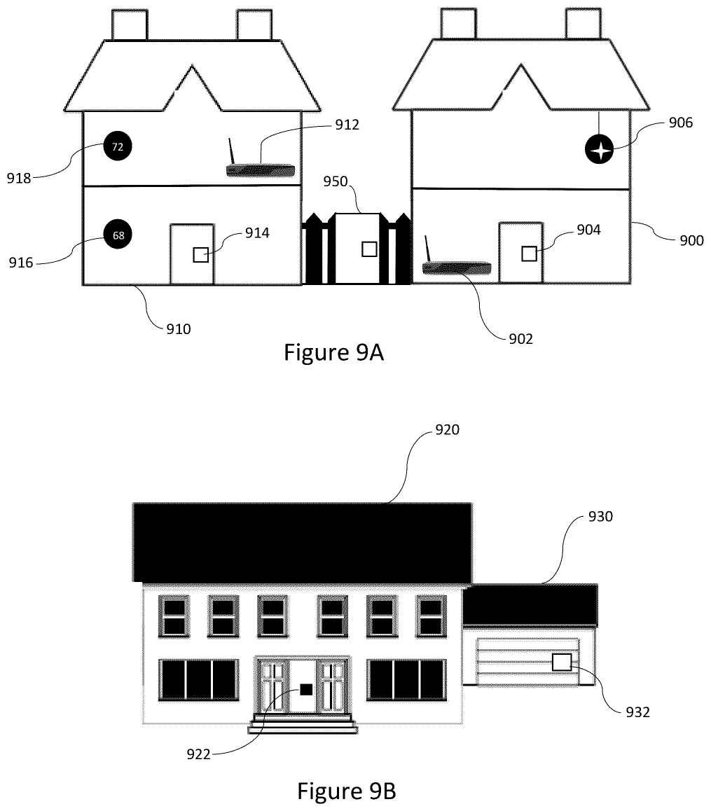

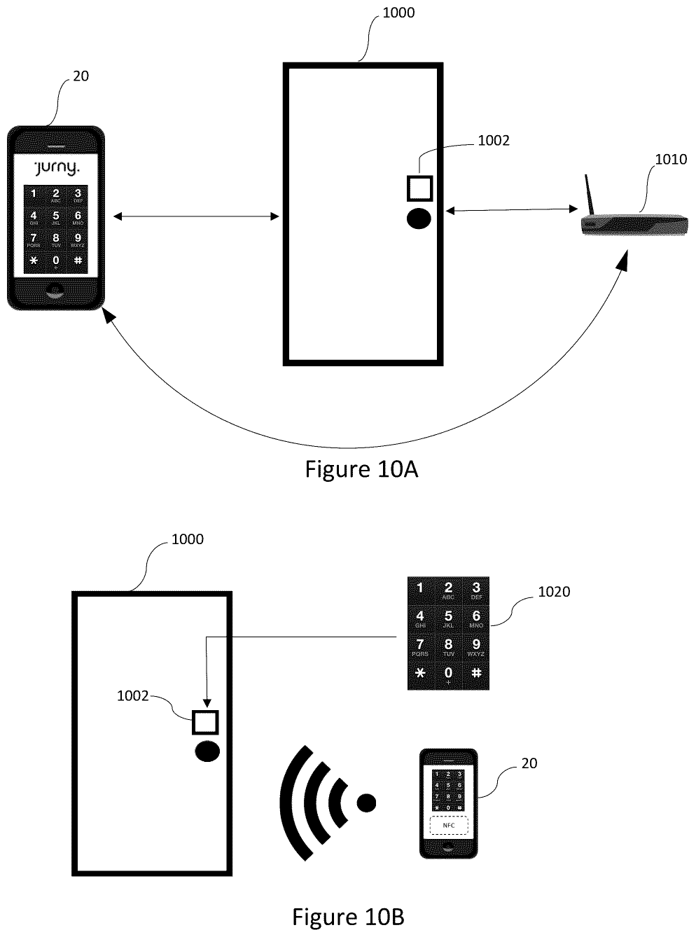

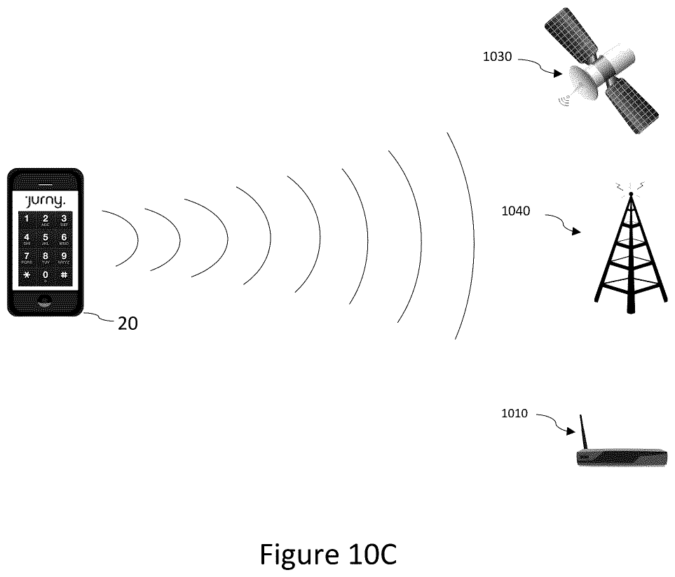

In one embodiment of the present invention, as shown in FIGS. 9A-B, the user device (or application operating thereon) may communicate with and/or control a smart device remotely (e.g., via the Internet, etc.). As discussed above, a command may be provided directly to the smart device, to the smart device via the host device, or to the smart device via the host device and a corresponding smart service. Regardless of how the communication is routed, the communication (e.g. command, etc.) will most likely be initiated by the user (e.g., via the user device, or the application operating thereon), communicated over a WAN (see, e.g., FIG. 10C at 1030 (satellite), 1040 (cellular tower), 1010 (Wi-Fi), etc.) and provided (either directly or indirectly) to the smart device.

As shown in FIGS. 9A-B, the command may be provided to a corresponding smart device via the unit's Wi-Fi (or internet) (902, 912). The smart device may be a smart locking device and may allow access to a first, second, or third unit (900, 910, 920) via first second or third doors (904, 914, 922), respectively, a common area via a common gate 950, or a garage 930 via a garage door 932. The smart device may also be a smart light (e.g., 906), a smart thermostat (e.g., 916, 918), or any other smart accessory generally known to those skilled in the art.

Alternatively, or in addition, the smart device may be communicated with and/or controlled locally (e.g., via Bluetooth, NFC, a keypad, etc.). For example, as shown in FIGS. 10A-B, a door 1000 may be unlocked by entering an access code on the user device (or the application operating thereon). The code would then be sent to the smart locking device 1002 via a wireless signal, such as Bluetooth, NFC, etc. Alternatively, the user device may provide the user with (e.g., display) the access code, thereby allowing the user to enter it via a keypad 1020 located adjacent (or near) the door 1000.

It should be appreciated that a smart device that can be locally controlled (e.g., via an adjacent keypad, Bluetooth, NFC, etc.) may also be remotely controlled (as previously discussed) (see, e.g., FIG. 10A). It all depends on what capabilities the smart device supports. It should also be appreciated that the smart device may also be controlled in other ways. For example, the smart device may be activated (e.g., unlock, turned on, etc.) merely by approaching the smart device (or smart home). This may be accomplished via Bluetooth (or the like), GPS (or the like, such as cell tower triangulation, etc.), etc., to determine proximity to the smart device and/or unit. Once the smartphone is relatively close, an activation signal may be transmitted to the smart device. The smart device may also be deactivated (e.g., locked, turned off, etc.) automatically (e.g., lack of proximity) or manually (e.g., sending a lock command) (e.g., from the user device, from the host device or service after the check-out date, etc.).

It should further be appreciated that the user device (or application operating thereon) may further be configured to provide information regarding the rental (or smart devices located therein) to the user. For example, this may include temperature, location, amenities, check-in date, check-out date, Wi-Fi name, Wi-Fi password, access code (door lock, alarm system, etc.) (see, e.g., FIGS. 16A-E).

With respect to the access code, the code for each smart device is generally selected and provided by the smart service. Thus, a service for a first common door (e.g., parking structure) may select and provide a first code (e.g., 1234), a service for a second common door (e.g., pool) may select and provide a second code (e.g., 987654), and a service for a unit door (e.g., front door) may select and provide a third code (e.g., Name123). This can be quite confusing for the user, especially when the codes are only going to be used for a limited amount of time (e.g., from the check-in date until the check-out date). And because these codes can be changed at will (e.g., if the service detects a security breach), a smart locking device may require more than one code during the user's stay.

The present invention solves this problem by (i) identifying the smart devices that are within (or associated with) the unit, (ii) identifying the corresponding smart services, (iii) acquiring and storing information on each smart service and/or device (e.g., access code requirements, etc.), (iv) generating at least one access code that complies with each code requirement for each smart service and/or device, (v) providing the access code to the user (e.g., via the application), and (vi) providing the access code and reservation information (e.g., unit, check-in date, check out date, etc.) to the smart service and/or device. Not only will this allow the smart service and/or device to prepare for the user's visit (e.g., programming the smart device so that the code only works during the user's stay), but it will provide the user with (preferably) a single code that works on all smart devices (e.g., all smart locking devices) during the user's stay.

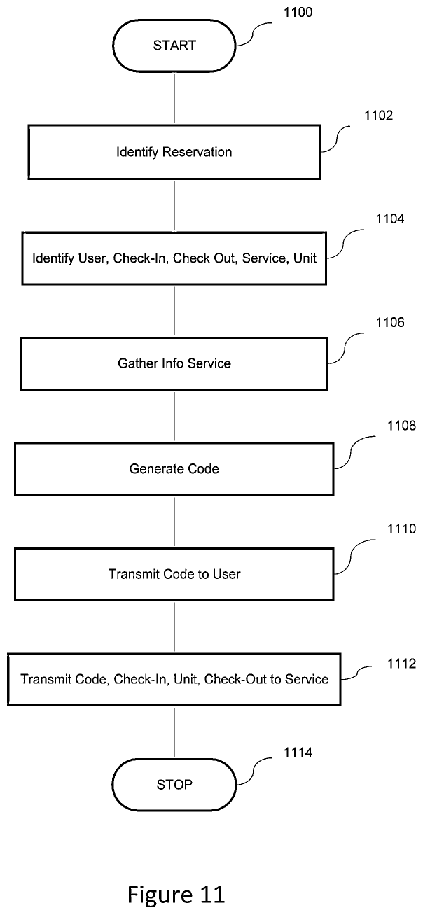

A method for generating and sharing an access code in accordance with one embodiment of the present invention is shown in FIG. 11. Starting at step 1100, a reservation is identified at step 1102. This may be accomplished by looking up user information (e.g., name, account number, etc.) in a database (e.g., on the host device) or requesting information from a reservation system. Once the user's reservation has been identified, the rental unit, check-in date, check-out date, and corresponding smart devices and/or services are identified at step 1104. Information on each smart device and/or service (e.g., access code requirements, etc.) is then gathered at step 1106. This information may be stored in a database (e.g., on the host device) or may be looked up for known smart devices that are in (or associated with) the unit. The known smart devices and/or associated services may also be stored in a database (e.g., on the host device). An access code for the smart devices and/or services is then generated by the host device (or application operating thereon) at step 1108. Preferably, a single access code is generated that will work on all smart locking devices for the unit. The code is then transmitted to the user at step 1110 (e.g., via the application operating on the user device) and to the smart services and/or devices, along with the check-in date, check-out date, unit ID, etc., at step 1112, ending the method at step 1114.

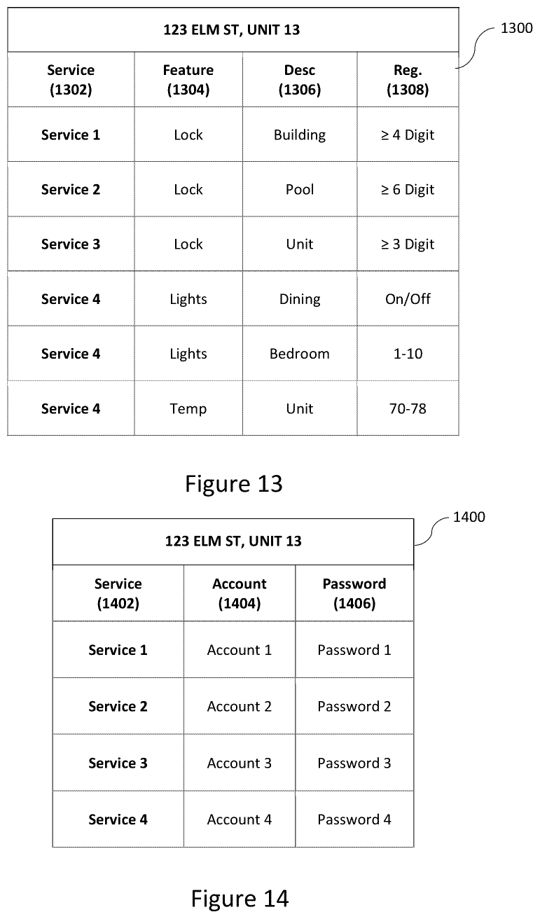

It should be appreciated that the present invention is not limited to FIG. 11, and methods having different, more, or fewer steps are within the spirit and scope of the present invention. For example, the step of generating a code may involve several other steps to ensure that the code complies with code requirements for each smart service and/or device and remains (relatively) unique. This can be seen in FIG. 13, where a unit 1300 uses four different services 1302, where each service controls (or is associated with) at least one feature 1304, which may have corresponding descriptions 1306 and requirements 1308. For example, a first service is associated with a lock on the building, where the lock requires at least a four digit code, a second service is associated with a lock on the pool, where the lock requires at least a six digit code, a third service is associated with a lock on the unit, where the lock requires at least a three digit code, and a fourth service is associated with dining room lights (can be turned on or off), bedroom lights (can be illuminated (or dimmed) on a scale of 1-10), and a thermostat for the unit that can be adjusted from 70-78.

Information regarding amenities (a dining room light that can be turned on or off, a bedroom light that can be adjusted for brightness on a scale of 1-10, and a thermostat that can be adjusted from 70-78 degrees) can then be provided to the user (e.g., via a user device or an application operating thereon), and a single access code can be generated that will work on each smart device during the user's stay (in this case, a code that is equal to or greater than six digits, which complies with code requirements for each smart service and/or device (i.e., equal to or greater than four digits, equal to or greater than six digits, and equal to or greater than three digits)). In one embodiment, the code is generated by the host device. In another embodiment, the requirements are provided to the user, thereby allowing the user to generate an easy-to-remember code (e.g., their PIN number, etc.). In yet another embodiment, the code is generated by one of the smart services. In other embodiments, the code is generated by one party (e.g., the host, a smart service, etc.) using information provided by another party (e.g., the host, a smart service, the user, etc.), such as an account number, a random number, information associated with the reservation (e.g., payment info, check in date, check out date, etc.), etc., where the provided information is part of (or used to generate) the code (e.g., a seed for a random number generator, the last four digits of a six digit code, etc.).

Once the code is generated, it will then be provided to the user and the smart service and/or device. With respect to the latter, the code is provided together with other information (e.g., identifying the unit, the check-in date, the check-out date, etc.). In one embodiment, as shown in FIG. 14, this is accomplished using login information for the unit 1400, which may include account information 1404 (e.g., user-name, account number, etc.) and password 1406 for each smart service and/or device 1402. This will allow the host device to communicate with each smart service and/or device autonomously (without burdening the property owner, user, etc.).

It should be appreciated that code requirements may be more complex than those illustrated in FIG. 13. For example, instead of a numerical code, the smart service and/or device may require a numeric code or an alphanumeric code (e.g., one capital letter, one symbol, one number, etc.). Thus, generating a code that will work for more than one service/device may be quite complex. And even if the codes are numeric, as shown in FIG. 13, certain codes may not be available for use. By way of example, the code “123456” may meet the requirements for each service (e.g., greater than or equal to 3, 4 and 6 digits) but may already be used by at least one service and linked to a different activation and/or deactivation date/time. Thus, in one embodiment of the present invention, a code must be generated that not only meets the requirements but is unique from other codes that are already in use. To accomplish this, a code will be generated and provided to each service/device. If it is rejected (e.g., already in use), another code will be generated and provided to each service/device until it is accepted by all. Alternatively, if it is rejected by one, but accepted by at least one other one, more than one code can be used, and provided to the user. This is not preferred, as it would require the user to remember more than one access code, but it is within the spirit and scope of the present invention.

A code should be considered unique (and therefore acceptable) if it is not being used by another user for dates that overlap the rental period for the user. For example, if a first user is using “1234” for 5/1/20-5/8/20, “1234” would not be acceptable for a second user for 5/2/20-5/9/20, as such a code could result in the second user accessing the unit (or common areas) a day early, or would prevent the first user from accessing the unit (or common areas) on their last day. Such a code may also not be acceptable if the time periods do not overlap, but are too close together (e.g., within one day apart), as such could result in the second user getting in early, or the first user staying late.

Given that there may be a limited number of combinations, the unit in question, or the proximity of the unit in question to the rental unit may also be taken into consideration. For example, a code may be considered unique even if it is being used by another, as long as the other is renting a different unit, a unit that is on a different floor, or a unit that is in a different building or complex. Thus, using the foregoing example, if the first user is in the downtown Hilton™ and the second user is in the uptown Hilton™, the code may be considered unique, regardless of any overlap in rental period. By way of another example, if both users are staying at the same hotel (e.g., downtown Hilton™), but are in different buildings, or on different floors, then the code may also be considered unique, regardless of any overlap in rental period. By way of yet another example, if the first and second user are staying in different units, regardless of the proximity to one another, the code may be considered unique, regardless of any overlap in rental period. The foregoing restrictions (or any portions thereof) may be put in place by the device, the service, or the host, depending on system requirements. Other requirements are within the spirit and scope of the present invention. For example, certain numbers (or sequences) may not be allowed (e.g., too simplistic, used for maintenance, used as a dummy code, etc.).

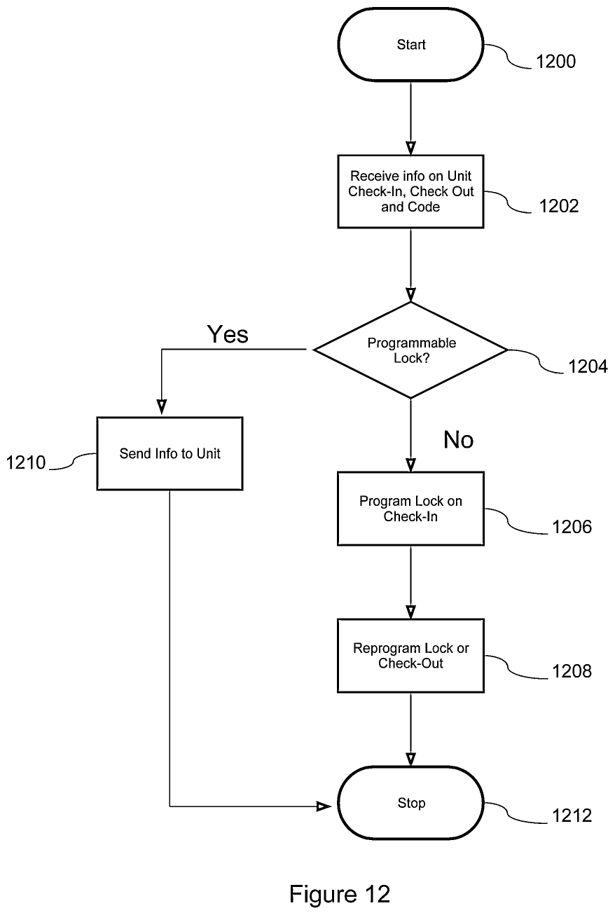

Once the code is received by the smart service, a method of using the code in accordance with one embodiment of the present invention is shown in FIG. 12. Starting at 1200, the code and associated information (e.g., user ID, unit ID, check-in date, check-out date, etc.) is received at step 1202. A determination is them made as to whether the smart device (e.g., smart lockable device) is programmable at step 1204. If it is, programming data (e.g., code, activation date, activation time, deactivation date, deactivation time, etc.) is provided to the smart device at step 1210. This allows the smart device (itself) to determine when the code is acceptable. If the smart device is not programmable, then the service will store the code and associated information and provide the code to the smart device at the appropriate time (e.g., program the smart device with the code at the check-in date/time) at step 1206. At the appropriate time (e.g., at the check-out date/time), the service will then reprogram (or deprogram) the device so that the code will not grant access at step 1208, ending the method at step 1212. This may either involve informing the device that the code is no longer active or replacing the first code with a second code, where the second code is either a new code (different code for a new renter) or a dummy code (just to replace the code from memory with one that is not ever put in use) (e.g., “123456”).

It should be appreciated that the present invention is not limited to FIG. 12, and methods having different, more, or fewer steps are within the spirit and scope of the present invention. For example, as discussed above, if the code is currently being used (or conflicts with a code that will be in use), then the service may refuse the code or request that another code be provided. This will prevent code overlap or interference, which may result in a user getting access to the unit sooner or preventing a user from having access for their entire stay.

As discussed above, an application may be downloaded to and operated on a user device, such as a smartphone, and can be used (in certain embodiments) to make a reservation and (in other embodiments) to present rental (including smart device) information to the user and allow a user to control certain features (e.g., turn on lights, adjust temperature, open doors, gates, structures, etc.). FIGS. 15A-16E show exemplary screen shots of such an application.

As shown in FIG. 15A, a user may login to the application, e.g., by entering a user name 1500 and password 1502. As shown in FIG. 15B, the user may then be allowed to make a reservation by searching for a location 1504 (e.g., Los Angeles). The user may be allowed to select features of the reservation, such as the date of the reservation, number of guests, number of nights, bedrooms, bathrooms, amenities, etc. (see, e.g., FIG. 15C). Results can then be presented to the user (see, e.g., Figure allowing the user to “book” the reservation 1510. Additional screen shots may be presented to the user, allowing the user to enter contact information, payment information, etc. Alternatively, previously presented information (linked to the user's account) may be used to book the reservation. As discussed above, alternate reservation sites may be used (e.g., airbnb™, expedia.com™, etc.), where reservation information is provided to (or acquired by) the host device.

By selecting the number of guests, the system can confirm that it is within the maximum occupancy of the rental, and if not, suggest alternatives (e.g., an alternative rental, additional rooms (e.g., in a hotel), etc.). The user may also be required to provide detailed information on each user (name, etc.), which would allow the system to generate individual codes for each guest, thereby providing enhanced security for the property owner and renters (of the unit and related units). It should be appreciated, however, that a single code for the reservation, regardless of the number of guests in the reservation, is within the spirit and scope of the present invention.

Once a reservation has been made, the user may be provided with information on the reservation (e.g., the unit) and allowed to control related features (e.g., smart devices located within or associated with the unit). For example, as shown in FIG. 16A, the user may be presented with a control dial 1600 that can be rotated to receive information and/or control at least one feature. For example, the user may rotate the dial 1600 to receive “check in info” 1602, which may include information on parking, street access, etc.

As shown in FIG. 16B, the user may rotate the dial 1600 to Wi-Fi 1604, which may allow a user to connect the user device to the unit's Wi-Fi (e.g., by selecting “connect,” which uses a saved name and password to connect the user device to the unit's Wi-Fi) or view related information (e.g., name and password), thereby allowing the user to connect other devices to the unit's Wi-Fi.

As shown in FIG. 16C, the user may rotate the dial to temperature 1606, which may allow the user to view temperature information (e.g., unit temperature, acceptable temperature range, outside temperature, etc.) and/or control the same (e.g., control the unit's temperature) (e.g., between an acceptable temperature range, etc.).

As shown in FIG. 16D, the user may rotate the dial 1600 to amenities 1608 to view amenity information (e.g., pool, gym, etc.). Finally, as shown in FIG. 16E, the user may rotate the dial 1600 to lock door 1610, allowing the user to view information on access (e.g., doors (e.g., common doors, unit doors, etc.) and corresponding access codes, a single access code) (e.g., allowing the user to enter a code on a digital keypad on their phone or an actual keypad on the unit) or to lock and/or unlock individual doors (e.g., clicking on a “lock” button, an “unlock” button, or displaying a digital keypad and allowing the user to enter an access code). In one embodiment, the user device's location is used (e.g., by the application operating on the user device, by the host device, etc.) to determine which door the user is near and thereby which door should be unlock and/or locked.

It should be appreciated that the foregoing screen shots are exemplary and are therefore not limitations of the present invention. Other screen shots, including different ways of presenting information, the presentation of different information, different ways of controlling smart devices, and different smart devices to be controlled, are within the spirit and scope of the present invention.

The foregoing description of a system and method for using an application operating on a smartphone and a network-connected host to at least receive information on a rental unit during a time period (e.g., from a check-in date until a check-out date) and to control a plurality of smart devices, including at least a smart locking device, during said time period, has been presented for the purposes of illustration and description. It is not intended to be exhaustive or to limit the invention to the precise forms disclosed, and many modifications and variations are possible in light of the above teachings. Those skilled in the art will appreciate that there are a number of ways to implement the foregoing features, and that the present invention it not limited to any particular way of implementing these features. The invention is solely defined by the following claims.

What is claimed is:

1. A method for controlling access to a plurality of units that are being reserved by a plurality of users for individual time periods, comprising:
storing a plurality of reservations in at least one memory device, wherein each reservation is associated with a corresponding unit, user, check-in date, and check-out date;
storing information on a plurality of services in said at least one memory device, wherein each one of said plurality of reservations is linked to at least one of said plurality of services, and each one of said plurality of services is configured to at least unlock at least one entry point associated with at least one of said plurality of units;
identifying for a first user a first reservation in said at least one memory device and a corresponding check-in date, check-out date, one of said plurality of units, and at least one of said plurality of services;
generating a unique code for said one of said plurality of services; and
sending said unique code to said first user and said unique code, said check-in date, and said check-out data to said one of said plurality of services over a wide area network (WAN);
wherein said one of said plurality of services is configured to program at least one entry point for said one of said plurality of units with said unique code starting said check-in date and ending said check-out date, said unique code being entered by said first user when said first user is in close proximity to said entry point for said one of said plurality of units to unlock said entry point.

2. The method of claim 1, wherein said information stored on said plurality of services includes unique ID requirements, said step of generating said unique code further comprises generating said unique code in accordance with said unique ID requirements for said one of said plurality of services.

3. The method of claim 1, wherein said first reservation is linked to at least first and second ones of said plurality of services, and said step of sending said unique code further comprises sending said unique code, said check-in date, and said check-out date to said first and second ones of said plurality of services over said WAN.

4. The method of claim 3, wherein said information stored on said plurality of services includes unique ID requirements, said step of generating said unique code further comprises generating said unique code in accordance with said unique ID requirements for both said first and second ones of said plurality of services.

5. The Method of claim 1, wherein said step of sending said unique code further comprises sending said unique code to an application operating on said user's smartphone, said application presenting said unique code to said user, thereby allowing said user to enter said unique code into a keypad at said entry point in order to unlock said entry point.

6. The method of claim 1, wherein said step of sending said unique code further comprises sending said unique code to an application operating on said user's smartphone, said application transmitting said unique code wirelessly to a locking mechanism at said entry point in order to unlock said entry point.

7. The method of claim 6, wherein said locking mechanism is a network-enabled lock configured to communicate with said one of said plurality of services via said WAN.

8. The method of claim 1, further comprising the steps of receiving at least one command to control at least one accessory from an application operating on said user's smartphone and transmitting said command to said one of said plurality of services to control said accessory, said accessory comprising at least one of temperature and lights.

9. The method of claim 1, further comprising the steps of receiving at least one command to control at least one accessory from an application operating on said user's smartphone and transmitting said command to one other one of said plurality of services to control said accessory, said accessory comprising at least one of temperature and lights.

10. The method of claim 1, further comprising the step of transmitting WiFi information to an application operating on said user's smartphone, said application being configured to use said WiFi information to connect said smartphone to a WiFi associated with said one of said plurality of units and to present said WiFi information to said user, thereby allowing said user to connect other devices to said WiFi.

11. A system for controlling access to a plurality of units that are being reserved by a plurality of users for individual time periods, comprising:
at least one host in communication with at least one wide area network (WAN) and comprising at least one memory device for storing machine readable instructions adapted to perform the steps of:
store a plurality of reservations, wherein each reservation is associated with a corresponding unit, user, check-in date, and check-out date;
store information on a plurality of services, wherein each one of said plurality of reservations is linked to at least one of said plurality of services, and each one of said plurality of services is configured to at least unlock at least one entry point associated with at least one of said plurality of units;
identify from said plurality of reservations and for a first user a first reservation and a corresponding check-in date, check-out date, one of said plurality of units, and at least one of said plurality of services;
generate a unique code for said one of said plurality of services; and
sending said unique code to said first user and said unique code, said check-in date, and said check-out data to said one of said plurality of services over a wide area network (WAN);
wherein said one of said plurality of services is configured to program at least one entry point for said one of said plurality of units with said unique code starting said check-in dated and ending said check-out date, said unique code being entered by said first user when said first user is in close proximity to said entry point for said one of said plurality of units to unlock said entry point.

12. The system of claim 11, wherein said information stored on said plurality of services includes unique ID requirements, said step of generating said unique code further comprises generating said unique code in accordance with said unique ID requirements for said one of said plurality of services.

13. The system of claim 11, wherein said first reservation is linked to at least first and second ones of said plurality of services, and said step of sending said unique code further comprises sending said unique code, said check-in date, and said check-out date to said first and second ones of said plurality of services over said WAN.

14. The system of claim 13, wherein said information stored on said plurality of services includes unique ID requirements, said step of generating said unique code further comprises generating said unique code in accordance with said unique ID requirements for both said first and second ones of said plurality of services.

15. The system of claim 11, wherein said step of sending said unique code further comprises sending said unique code to an application operating on said user's smartphone, said application presenting said unique code to said user, thereby allowing said user to enter said unique code into a keypad at said entry point in order to unlock said entry point.

16. The system of claim 11, wherein said step of sending said unique code further comprises sending said unique code to an application operating on said user's smartphone, said application transmitting said unique code wirelessly to a locking mechanism at said entry point in order to unlock said entry point.

17. The system of claim 11, further comprising the steps of receiving at least one command to control at least one accessory from an application operating on said user's smartphone and transmitting said command to said one of said plurality of services to control said accessory, said accessory comprising at least one of temperature and lights.

18. The system of claim 11, further comprising the steps of receiving at least one command to control at least one accessory from an application operating on said user's smartphone and transmitting said command to one other one of said plurality of services to control said accessory, said accessory comprising at least one of temperature and lights.

19. The system of claim 11, further comprising the step of transmitting WiFi information to an application operating on said user's smartphone, said application being configured to use said WiFi information to connect said smartphone to a WiFi associated with said one of said plurality of units and to present said WiFi information to said user, thereby allowing said user to connect other devices to said WiFi.

20. A method for controlling access to a plurality of units that are being reserved by a plurality of users for individual time periods, comprising:
storing a reservation and information on a service in at least one memory device, said reservation being associated with a unit, a user, a check-in date, and a check-out date, said service being configured to at least unlock an entry point associated with said unit by communicating with a locking mechanism associated with said entry point via a wide area network (WAN);
using said information on said service to generating an acceptable access code;
sending said access code to an application operating on said user's smartphone; and
sending said access code, said check-in date, and said check-out data to said service over said (WAN);
wherein said service is configured to program said locking mechanism with said access code starting on said check-in date and ending on said check-out date, said access code being presented to said user via said application operating on said smartphone, thereby allowing said user to enter said access code into a keypad associated with said locking mechanism.
